(19) United States
(12) Patent Application Publication
(10) Pub. No.: US 2009/0312938 A1
(43) Pub. Date: Dec. 17, 2009

(54) GAS SENSOR, OXYGEN SENSOR AND AIR-FUEL RATIO CONTROL SYSTEM

(75) Inventors: Kousaku Morita, Yokohama (JP); Akira Uchikawa, Midori (JP); Masami Kawashima, Ooizumi (JP); Shoichi Sakai, Midori (JP); Masao Tsukada, Isesaki (JP); Keiji Mori, Isesaki (JP); Shosaku Ishihara, Chigasaki (JP); Tsuyoshi Fujita, Yokohama (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/482,173

(22) Filed: Jun. 10, 2009

(30) Foreign Application Priority Data
Jun. 11, 2008 (JP) 2008-153010
Jun. 5, 2009 (JP) 2009-135786

(51) Int. Cl. F02D 41/00; G01N 27/26

(52) U.S. Cl. 701/109; 204/431

(57) ABSTRACT

The invention provides an air-fuel ratio control system in which high precision can be applied to the air-fuel ratio feedback control of an engine by using a gas sensor mainly configured by an oxygen sensor that prevents the deterioration of the holding power of sealing material which enables high density filling with a small compressive load or the deterioration of the sealing material. The gas sensor such as the oxygen sensor is based upon a gas content detecting sensor that includes a gas content detecting element and a holder holding the gas content detecting element and that seals a measuring part of the gas content detecting element in the holder by a sealing part in which the sealing material is compressively filled, and has a characteristic that the sealing material is molded by mixed powder including plural species of forms of particles.

### BACKGROUND OF THE INVENTION

The present invention relates to a gas sensor that is installed in an exhaust system of an internal combustion engine mounted in a vehicle for example and that detects a specific component in exhaust gas.

Generally, an oxygen sensor for example is provided to a vehicle such as an automobile on an exhaust pipe and feedback control over the air-fuel ratio of an engine is made by detecting an oxygen content in exhaust gas using the oxygen sensor.

An oxygen sensor is known in which both a detecting element and a holder are sealed and positioned by compressively filling space between the detecting element that detects an oxygen content and the holder having an insertion hole for inserting the detecting element with ceramic powder (for example, refer to JP-A No. 2005-241346).

### SUMMARY OF THE INVENTION

In the above-mentioned related art, however, a porous film is formed on a surface of the oxygen content detecting element. Therefore, a compressive load is required to be limited, and it is difficult to acquire sufficient holding power between the detecting element and the holder.

The invention is made in view of the above-mentioned situation and the invention provides a gas sensor including an oxygen sensor that can firmly hold a detecting element and a holder by sealing material which enables high density filling with a small compressive load.

To achieve the object, the invention is based upon an oxygen sensor which is configured by an oxygen content detecting element and a holder that holds the oxygen content detecting element and in which the oxygen content detecting element is sealed in the holder by a sealing part in which sealing material is compressively filled and has a characteristic that the sealing material is molded by mixed powder including plural species of forms of particles.

According to the invention, the high density sealing material is acquired with a small compressive load by using the mixed powder including the plural species of forms of particles for the sealing material.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a general sectional view showing an oxygen sensor according to one embodiment of the invention;

FIG. 2 is an enlarged sectional view showing a main part of the oxygen sensor according to one embodiment of the invention;

FIGS. 3A and 3B show a sensor body, wherein FIG. 3A is a side view showing the sensor body, and FIG. 3B is a sectional view viewed along a line A-A in FIG. 3A;

FIG. 4 is a graph showing relation between spherical alumina added quantity and porosity;

FIG. 5 is a structural drawing showing a pressurized state of mixed powder including spherical alumina;

FIG. 6 is a graph showing the particle size distribution of flaky talc particles and spherical alumina particles;

FIG. 7 is a graph showing a relation between the particle size of spherical alumina and a molding load;

FIG. 8 is a graph showing a relation between the ratio (D/L) of a diameter D of a spherical particle and the length L of a flaky talc particle and porosity;

FIG. 9 is a graph showing a relation between the porosity of mixed powder including spherical alumina particles and the quantity of air leakage;

FIG. 10 is an illustration showing a method of producing sealing material;

FIG. 11 is a graph showing a relation between molding pressure and porosity; and

FIG. 12 is a schematic diagram showing an air-fuel ratio control system.

### DESCRIPTION OF THE PREFERRED EMBODIMENT

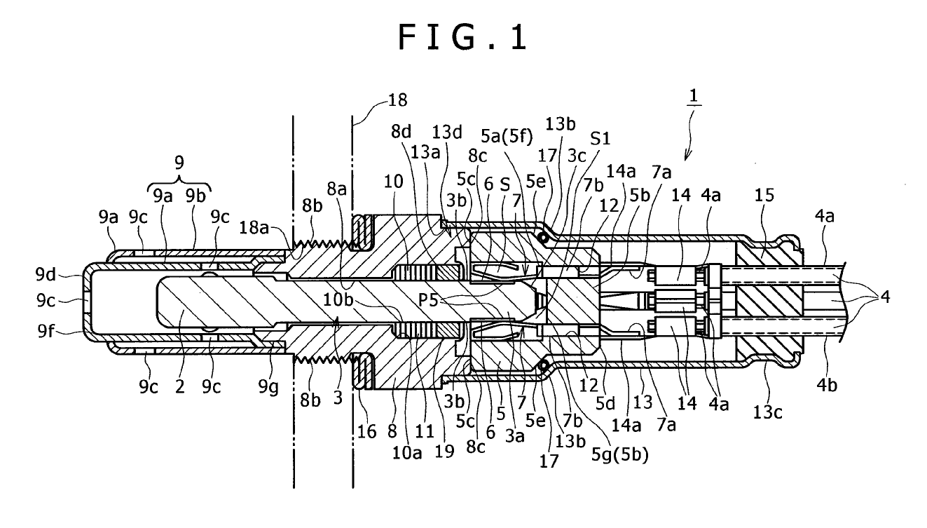

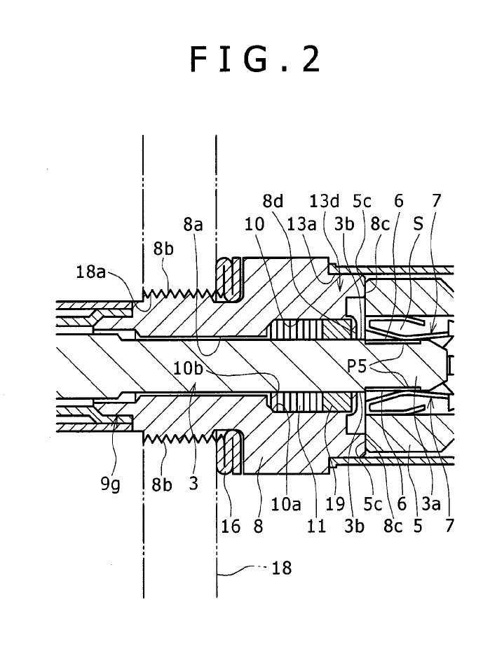

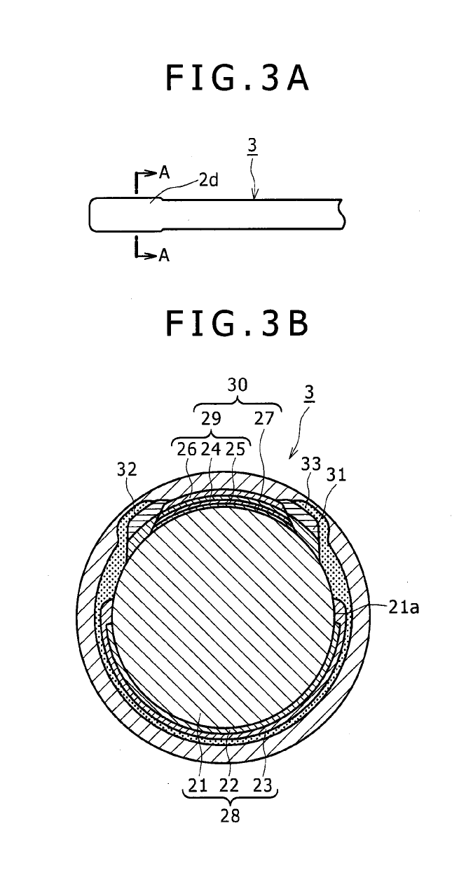

FIG. 1 is a longitudinal section showing an oxygen sensor according to one embodiment of the invention, FIG. 2 is an enlarged sectional view showing a main part of the oxygen sensor according to one embodiment of the invention, FIGS. 3A and 3B show a sensor body of the oxygen sensor according to one embodiment of the invention, wherein FIG. 3A is a side view showing the sensor body, and FIG. 3B is a sectional view viewed along a line A-A in FIG. 3A.

The oxygen sensor (the gas sensor) 1 according to this embodiment is provided with the long cylindrical sensor body 3 and a cylindrical insulator 5 to which terminals 7 and lead wires 4 are attached as shown in FIG. 1.

A gas detecting part 2 is formed on one side (on the downside in FIG. 1) in an axial direction of the sensor body 3. An electrode 6 is provided to an outside face 3b as a surface on the other side (on the upside in FIG. 1) in the axial direction of the sensor body 3 with the electrode exposed. The electrode 6 is electrically connected to the gas detecting part 2.

A concave portion 5f concave toward the other side in the axial direction is formed on an end face 5c on one side in an axial direction of the insulator 5, plural hooked parts of the terminals 7 are arranged along an inside face 5a of the concave portion 5f, and a connective end 3a of the sensor body 3 is fitted between these plural terminals 7.

That is, in a state in which the sensor body 3 and the insulator 5 are assembled, the hooked part of the terminal 7 is arranged in space S formed between the inside face 5a of the concave portion 5f of the insulator 5 and the outside face 3b of the connective end 3a, and is held between the inside face 5a and the electrode 6 exposed on the outside face 3b.

At this time, the terminal 7 is touched to the electrode 6 at a contact P5.

The terminal 7 is pressure-connected to the electrode 6 by repulsion generated because of being held as described above and is electrically connected to the electrode 6. The terminal 7 is electrically connected to a core 4a in the lead wire 4 via a combining part 14 on the other side in the axial direction. That is, the gas detecting part 2 is electrically connected to the core 4a in the lead wire 4 via the electrode 6, the terminal 7 and the combining part 14.

One end 7a of the terminal 7 is spot-welded to a leading plate 14a protruded from the combining part 14 of the lead wire 4.

A fixed part 7b is formed with the fixed part widened and its cross section substantially C-type and is fitted into a mounting hole 12 of the insulator 5.

The sensor body 3 is fitted into an insertion hole 8a of a holder 8. At this time, the gas detecting part 2 of the sensor body 3 is exposed on one side (on the downside in FIG. 1) of the holder 8. In the meantime, the connective end 3a of the sensor body 3 is exposed on the other side (on the upside in FIG. 1) of the holder 8 and the connective end 3a is fitted to the bottom 5g of the insulator 5 with a void S1 in the axial direction. Therefore, when the sensor body 3 and the insulator 5 are assembled or even if the sensor body 3 is moved because of the vibration and the like of a vehicle for example after the assembly, the sensor body 3 never touches the bottom 5g of the insulator 5.

In the state in which the sensor body 3 and the insulator 5 are assembled, the holder 8 and the insulator 5 are mutually put opposite in the axial direction, and an end face 8c on the other side in an axial direction of the holder 8 and the end face 5c on one side in the axial direction of the insulator 5 are mutually touched.

Further, in this embodiment, the insertion hole 8a of the holder 8 is formed in a slightly larger diameter than a diameter of the sensor body 3 so as to enable the sensor body 3 to be smoothly inserted and in a state in which the sensor body 3 is inserted into the insertion hole 8a, predetermined clearance is formed between an inside face of the insertion hole 8a and the periphery of the sensor body 3.

The gas detecting part 2 is covered with a bottomed cylindrical protector 9 configured by double tubes 9a, 9b fixed to the holder 8 by welding (9g), caulking and others.

The protector 9 is provided with the inner protector 9a and the outer protector 9b respectively formed by metallic materials or ceramic materials for example. The protector 9 is arranged on the end side of the holder 8 and the end side of the sensor body 3 protruded from the holder 8 is inserted inside the protector.

A diameter of the end side 9e of the outer protector 9b is contracted inside in a radial direction toward the inner protector 9a and a circular fitting opening 9f fitted to the peripheral side of the inner protector 9a by a clearance fit is provided to the contracted part.

As described above, the gas detecting part 2 can be protected from foreign matters in exhaust gas by covering the protruded end side of the sensor body 3 with the inner protector 9a and the outer protector 9b.

A flow-through hole 9c for a flow of gas is formed at the end 9d on one side (on the downside in FIG. 1) of the inner protector 9a. Gas to be detected enters the protector 9 through the flow-through hole 9c and reaches the circumference of the gas detecting part 2.

Sealing material housing space 10 acquired by widening a diameter of the insertion hole 8a is formed on the other end side (on the upside in FIG. 2) in the axial direction of the holder 8. A sealing part 11 is formed by filling the sealing material housing space 10 with heatproof sealing material 11a and the airtightness of clearance between the sensor body 3 and the insertion hole 8a is held by the sealing part 11.

The sealing material 11a is filled in a pressurized sate by bending a pressing member 19 arranged in the sealing material housing space 10 inside in a radial direction of the sensor body 3 by a caulking part 8d using means such as all around caulking, the sensor body 3 can be positioned in relation to the holder 8 as a result, and the sealing part 11 is provided with functions of closing clearance between the holder 8 and the sensor body 3, preventing outside moisture and others from permeating into the holder 8 and preventing exhaust gas and others in an exhaust pipe from infiltrating on the side of a casing 13.

At one end (on the downside in FIG. 2) in an axial direction of the sealing material housing space 10, an inclined face 10a a diameter of which is gradually narrowed in a loaded direction toward one side (the downside in FIG. 2) in the axial direction and a bottom 10b perpendicular to the axial direction are formed, and the inclination α of the inclined face 10a is set to approximately 45 degrees in this embodiment. As the stress to pressurization of the sealing material 11a is also dispersed on the side of the sensor body 3 by the inclined face 10a and the bottom 10b, the function of holding airtightness between the sensor body 3 and the holder 8 (the insertion hole 8a) and the closing and preventing functions are further enhanced.

The sealing material 11a is made of mixed powder including plural species of forms of particles. For example, the mixed powder includes flaky talc particles not sintered (mean particle diameter: 5 to 25 μm) and spherical alumina particles (mean particle diameter: 1 to 10 μm), and the sealing material housing space 10 is filled with the sealing material under pressure of approximately 10 kN.

Plural (four in this embodiment) mounting holes 12 for inserting the fixed part 7b of the terminal 7 are formed at the bottom 5b of the concave portion 5f of the insulator 4 at an equal interval in a circumferential direction. Arrangement of the plural terminals 7 at the equal interval in the circumferential direction as described above allows easy arrangement of the sensor body 3 held by the plural terminals 7 in the center of the concave portion 5f.

The periphery of the insulator 5 is covered with the substantially cylindrical casing 13. An opening 13a on the side of one end (a lower end in FIG. 1) in an axial direction of the casing 13 is fitted to an outside face of the holder 8, is integrated by laser beam welding and others, and is sealed (13d). In the meantime, the side of the other end (an upper end in FIG. 1) of the casing 13 is extended and covers the combining parts 14 of the plural lead wires 4, and the end is closed by contracting a diameter of heatproof seal rubber 15 such as fluoro rubber that lets the lead wire 4 pass airtightly by a caulking part 13c inside in a radial direction.

The airtightness of the space S provided between the insulator 5 and the connective end 3a is substantially held by the sealing part 11, the seal rubber 15 and a part 13d in which the casing 13 and the holder 8 are fitted. However, the space communicates with the outside via only slight clearance between the core 4a of the lead wire 4 and cladding material 4b so as to take a reference air used for detecting an oxygen content inside the casing 13.

The oxygen sensor 1 configured as described above is attached by screwing a screw 8b formed at one end of the holder 8 into a tapped hole 18a of the exhaust pipe 18 and in this state, and the gas detecting part 2 covered with the protector 9 is thrust into the exhaust pipe 18. The holder 8 and the periphery of the exhaust pipe 18 are sealed by a gasket 16.

When exhaust gas flowing in the exhaust pipe flows inside through the flow-through hole 9c of the protector 9, an oxygen content in the gas is detected by the gas detecting part 2 as an electric signal, and the information of the electric signal is extracted outside via a pair of electrodes 6, a pair of terminals 7, a pair of combining parts 14 and a pair of lead wires 4 respectively out of two pairs. A pair of electrodes 6, a pair of terminals 7, a pair of combining parts 14 and a pair of lead wires 4 respectively residual are used for heating a heater in the gas detecting part 2.

When the connective end 3a and the insulator 5 are assembled, they are relatively moved to a position (see FIG. 1) in which the end face 5c of the insulator 5 is put opposite to the end face 8c of the holder 8 in a direction in which the connective end 3a and the insulator 5 mutually approach in the axial direction of the sensor body 3. At this time, the connective end 3a is inserted into the concave portion 5f and is held by the plural (four arranged every 90 degrees in the circumferential direction of the sensor body 3 in this embodiment) terminals 7 arranged along the inside face 5a of the concave portion 5f.

In this embodiment, a tip of the connective end 3a of the sensor body 3 is chamfered (3c) all around. Hereby, a contact angle of the tip of the connective end 3a and the terminal 7 is reduced and the damage of the tip or the terminal 7 is inhibited.

In this embodiment, as shown in FIG. 1, a C-type ring 17 the section of which is C-type is provided between the casing 13 and the insulator 5 as an elastic member. The C-type ring 17 is annularly formed in this embodiment and is fitted to the insulator 5 with the ring surrounding the periphery of the insulator. The section of the C-type ring 17 is substantially in a C type an end of which is cut out.

The C-type ring 17 is held between the insulator 5 and the casing 13, generates resilient or elasto-plastic repulsion, and generates force that presses the insulator 5 on the side of the holder 8, that is, on one side (on the downside in FIG. 1) in the axial direction. Hereby, the insulator 5 is firmly fixed to the end face 8c of the holder 8.

As the C-type ring 17 is held between the periphery of the insulator 5 and the inside face of the casing 13, the C-type ring can inhibit the vibration in a direction perpendicular to a central axis (a vertical direction in FIG. 1) of the insulator 5. When a level of vibration transmitted from the exhaust pipe 18 is high, particularly in a case of a motorcycle that high-frequency vibration is caused, the displacement of the insulator 5 and the terminal 7 increases and the terminal 7 may be easily worn. In this embodiment, however, the vibration of the insulator 5 is inhibited by the C-type ring 17 and in collaboration with the effect of inhibiting the vibration of the insulator 5 by the terminal 7, the wear of the terminal 7 can be further inhibited by the C-type ring.

In this embodiment, a stepped part 5e a diameter of which is reduced toward the reverse side (the other side in the axial direction, the upside in FIG. 1) to the holder 8 is provided in a position between the end face 5c on one side in the axial direction and the end face 5d on the other side on the periphery of the insulator 5. A stepped part 13b a diameter of which is reduced toward the reverse side to the holder 8 is also provided to the casing 13, the C-type ring 17 is installed on the stepped part 5e, and the C-type ring 17 is held by the stepped parts 5e, 13b.

The oxygen sensor 1 is attached by screwing the screw 8b formed at one end of the holder 8 into the tapped hole 18a of the exhaust pipe 18. When the oxygen sensor is mounted in the exhaust pipe 18 of a vehicle, the amplitude of vibration transmitted from the exhaust pipe 18 becomes large on the side of the lead wires 4 far from the exhaust pipe 18 and becomes small in the vicinity of the exhaust pipe 18 (at a fixed end). In this embodiment, as the vibration can be inhibited so that the amplitude becomes smaller because the stepped 5e is provided and the C-type ring 17 can be arranged closer to the exhaust pipe 18, the effect of inhibiting vibration can be further increased and the C-type ring 17 can be miniaturized.

Further, in this embodiment, the C-type ring 17 is arranged outside the terminals 7 in the radial direction of the central axis of the sensor body 3 with the C-type ring surrounding the plural terminals 7.

In this embodiment, an inclined face (a tapered face a diameter of which is widened toward one side in the axial direction) inclined from the axial direction is provided to the stepped part 5e and the C-type ring 17 is installed on the inclined face. Therefore, the C-type ring 17 can apply resilience to the insulator 5 both in the axial direction and in the radial direction, and both effects of pressing the insulator 5 on the holder 8 and of inhibiting vibration can be acquired by a relatively simple configuration.

Next, referring to FIGS. 3A and 3B, the configuration of the sensor body 3 in one embodiment of the invention will be described.

The sensor body 3 in this embodiment is provided with a base 28 and the base 28 is provided with a heater core 21 as a core rod which is a heater to be an arbor formed in the shape of a long and thin rod and which is formed in the shape of a solid rod having a small diameter by ceramic material such as alumina, a heater pattern 22 and an insulating heater coated layer 23 as shown in FIG. 3.

The heater pattern 22 is made of exothermic conductive material such as platinum in which alumina is mixed and is formed on the periphery of the heater core 21 using means such as curved surface printing. The heater pattern 22 is provided with a pair of leads (not shown) extended from the side of an end of the heater core 21 to the side of a base and these leads are connected to each terminal 7 on the side of the base of the heater core 21.

The heater pattern 22 heats the heater core 21 by being fed from an outside power source for the heater (not shown) via each lead so that the temperature of the heater core 21 is between approximately 720° C. and approximately 800° C. for example.

The heater coated layer 23 is formed by printing ceramic material such as alumina on the side of the periphery of the heater core 21 to be a thick film by means such as a curved surface printing so as to protect the heater pattern 22 from the outside in the radial direction.

As shown in FIG. 3B, a functional layer 30 sequentially laminated including a relieving layer 27 formed in a separate position (an opposite position in the radial direction to the heater pattern 22 in this embodiment) from the heater pattern 22 and a protective layer 31 that generally covers the periphery of the functional layer 30 are laminated on a surface of the heater core of the base 28 using means such as curved face printing. The functional layer 30 may also be formed in a position corresponding to the heater pattern 22.

The functional layer 30 includes a solid electrolytic layer 24 having oxygen ion conductivity, an inner electrode layer 25 located on the side of the base 28 of the solid electrolytic layer 24, an outer electrode layer 26 located on the reverse side to the inner electrode layer 25 of the solid electrolytic layer 24 and the relieving layer 27 that is located on the side of the base 28 of the solid electrolytic layer 24 and that conducts outside air (atmosphere) which is reference gas toward the solid electrolytic layer 24 as shown in FIG. 3B.

The solid electrolytic layer 24 is made by printing and baking paste acquired by mixing powder of yttria of predetermined percentage by weight in powder of zirconia for example. The solid electrolytic layer 24 generates electromotive force according to difference in an oxygen content in the circumference between the inner electrode layer 25 and the outer electrode layer 26 and conveys an oxygen ion in a direction of the thickness. That is, an oxygen measuring part 29 that extracts an oxygen content as an electric signal is formed by the inner electrode layer 25 and the outer electrode layer 26 which are a pair of electrode layers with the solid electrolytic layer 24 between them. As shown in FIG. 3B, the solid electrolytic layer 24 is formed so that a part is touched to the heater core 21 and the relieving layer 27 described later. As described above, the relieving layer 27 is formed at least on an interface between the base 28 and the solid electrolytic layer 24.

The inner electrode layer 25 and the outer electrode layer 26 are made of material such as platinum which has conductivity and which oxygen can pass. Output voltage generated between the inner electrode layer 25 and the outer electrode layer 26 can be detected.

The relieving layer 27 is formed in the shape of a circular arc as shown in FIG. 3B by printing paste made of the powder-of alumina for example (the powder of zirconia of predetermined percentage by weight may also be mixed) on the peripheral side of a surface of the base 28 (the heater core 21 in this embodiment) using means such as curved surface printing to be a thick film.

The relieving layer 27 is formed in a porous structure having continuous holes and is provided with a function of transmitting unmeasured gas toward the inner electrode layer 25, diffusing a part of the unmeasured gas that flows in vicinity of the sensor body 3 inside the relieving layer 27.

In this embodiment, the relieving layer 27 is made of a ceramic mixture of insulating material such as alumina and a solid electrolyte such as zirconia and is also provided with a function of relieving stress difference generated between the solid electrolytic layer 24 and the heater core 21 when the solid electrolytic layer 24 is sintered.

Further, the protective layer 31 is formed on an outside face of the functional layer 30 except the solid electrolytic layer 24, a diffused layer 32 is formed on an outside face of the protective layer 31 so as to cover the protective layer 31 and the solid electrolytic layer 24, and a spinel-made protective layer 33 is formed on an outside face of the diffused layer 32 so as to cover an area including the outside face of the diffused layer 32.

The protective layer 31 is formed by material which oxygen in gas subject to measurement cannot pass, for example, ceramic material such as alumina. The protective layer 31 is formed so that the outer electrode layer 26 for example is exposed except an outside face of a part of the solid electrolytic layer 24 and an area of both electrode layers 25, 26.

The diffused layer 32 is formed of material which oxygen in gas subject to measurement can pass though toxic gas and dust in gas subject to measurement cannot pass it, for example, by a mixture having porous structure of alumina and magnesium oxide.

The spinel-made protective layer 33 has porous structure which can pass oxygen in gas subject to measurement and is formed by a porous body coarser than the protective layer 31.

In the above-mentioned related art, when a holder of a detecting element that detects an oxygen content is compressively filled with ceramic powder and both the detecting element and the holder are sealed and positioned, a compressive load is required to be limited so as to perform compression molding in a range in which no destruction of texture is caused in a porous film formed on a surface of the detecting element. In this case, the related art using one species of ceramic powder has a problem that it is difficult to acquire sufficient holding power between the detecting element and the holder.

In the meantime, in this embodiment, as high density sealing material is acquired at a low compressive load by using mixed powder including plural particles for the sealing material 11a filled in the sealing part 11 in this embodiment, the detecting element and the holder can be firmly held without breaking a multilayer film formed on the surface of the detecting element.

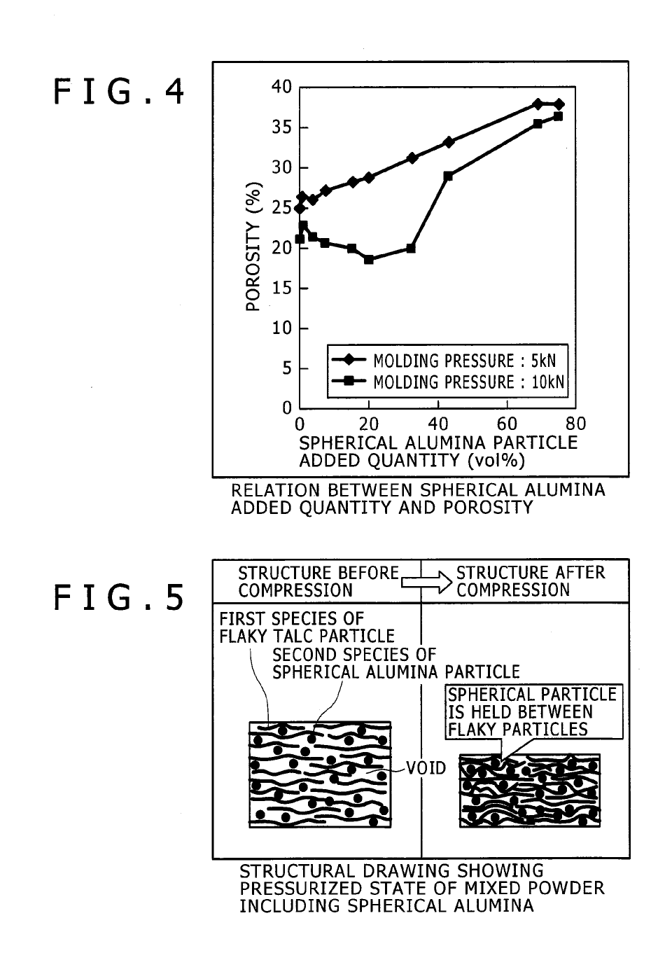

Next, for the sealing material 11a in one embodiment of the invention, an example of mixed powder including a flaky talc particle as a first form of particle and a spherical alumina particle as a second form of particle will be described referring to FIGS. 4 to 11.

FIG. 4 is a graph showing the formability of the sealing material 11a and shows spherical alumina powder added quantity (vol %) on an abscissa and porosity (%) on an ordinate. Molding pressure is set to 5 kN and 10 kN and the results of compression molding show that on a condition of the molding pressure of 5 kN, the porosity increases by increasing the mixed quantity of spherical alumina particles and a high density mixture cannot be formed. However, on a condition of the molding pressure of 10 kN, the effect of greatly reducing the porosity can be verified in a range in which the mixed quantity of spherical alumina particles is 3 to 30 vol %. The effect of mixing flaky talc particles with spherical alumina particles is verified based upon the above-mentioned.

Then, the microstructure of the sealing material 11a in this embodiment is examined. FIG. 5 is a structural drawing showing the results of the examination of the microstructure. In the sealing material 11a in this embodiment, a spherical alumina particle exists between flaky talc particles and it can be verified that vacancy is greatly reduced by deforming flaky talc particles in a compressive process. This effect can be verified in all areas of 0.5 to 75 vol % (flaky talc particles: 99.5 to 25 vol %) for which mixed spherical alumina particles account, however, when spherical alumina particles are mixed by 45 vol % or more, the die releasing after molding is deteriorated, and the detachment and a crack of the surface and the side are verified in a sealing material extraction process. It is desirable based upon the above-mentioned that spherical alumina particles are mixed by 45 vol % or less, preferably 30 vol % or less.

As the porosity can be reduced as described above, the density of a compact of the sealing material 11a is also enhanced and the firm sensor body 3 can be held. In the above-mentioned related art, there is a case that sealing material flows through clearance between the detecting element and the holder in compressively filling the sealing material. However, as a spherical alumina particle enters the clearance in this embodiment, the outflow of flaky talc particles can be simultaneously reduced. As a flow of gas can be blocked because a spherical particle enters between flaky particles, the sealability of the sealing material 11a can be made satisfactory.

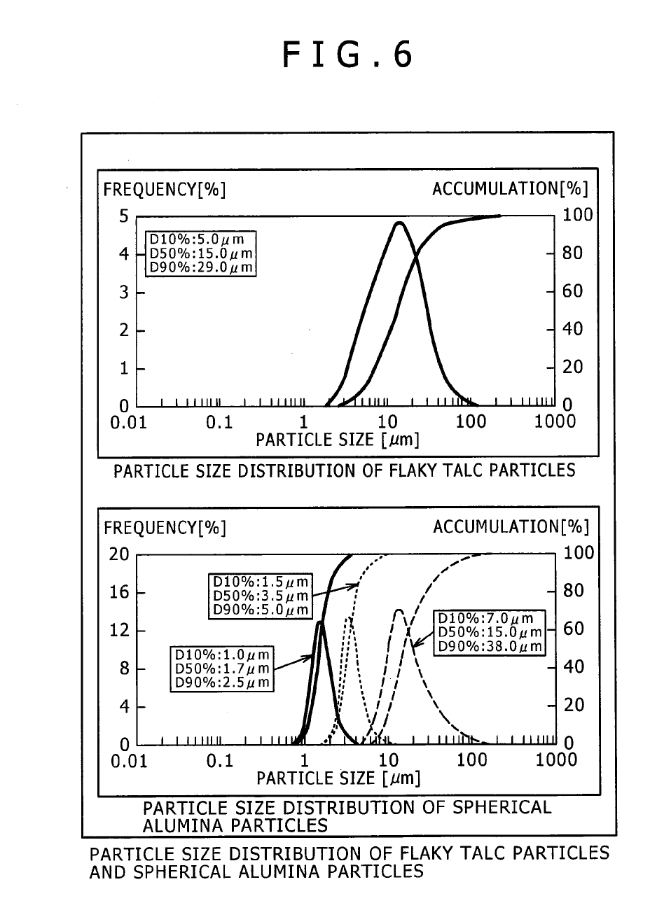

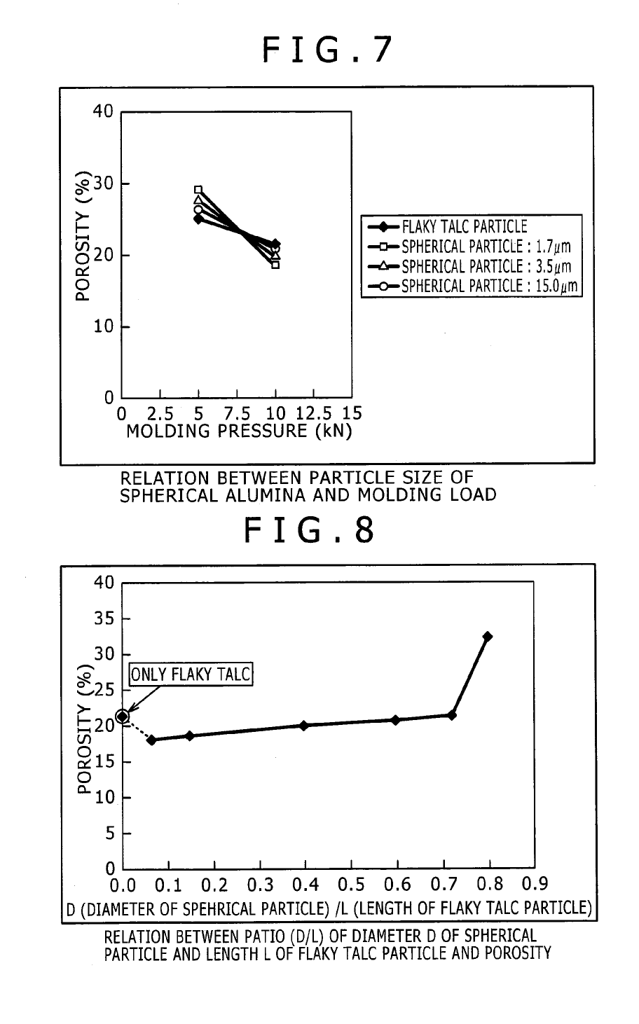

Next, FIG. 6 is a graph showing an example of the measured results of the particle size distribution of flaky talc particles and spherical alumina particles respectively used for compression molding. The particle size distribution of compressively molded flaky talc particles is 15.0 μm at D50% and the particle size distribution of spherical alumina particles is 1.7 to 15.0 μm at D50%. FIG. 7 is a graph showing relation between molding pressure (kN) shown on an abscissa and porosity (%) shown on an ordinate using a mean particle diameter of spherical alumina particles for a parameter. As shown in FIG. 7, when the molding pressure is 10 kN, a bigger particle size corresponds to higher porosity. However, the similar effect to a case that spherical alumina particle added quantity is increased (FIG. 4) is acquired. In this embodiment, a case that only a spherical alumina particle is used for a second spherical particle has been described as an example; however, if only the quantity of spherical particles added to flaky talc particles is 45 vol % or less to flaky talc particles, mixed powder of spherical alumina particles and spherical SiO₂ particles or mixed powder of spherical alumina particles, spherical SiO₂ particles and spherical ZrO₂ particles for example may also be mixed with flaky talc particles.

FIG. 8 is a graph showing relation between D/L and porosity (%) when molding pressure is 10 kN. D/L denotes the ratio of a diameter D of a spherical particle to the length L of a flaky talc particle. As a diameter of a spherical particle gets larger, the porosity increases, however, in an area to 0.7 in D/L, the effect of reducing porosity can be verified, compared with a case that no spherical particle is mixed. It is conceivable that this result shows an area in which a spherical particle exists between flaky talc particles and the circumference of the spherical particle can be covered with the length L of the flaky particles. As for spherical particle added quantity, as the similar effect to the case that added quantity is increased (FIG. 4) is acquired, any mixed powder of spherical alumina particles, spherical SiO₂ particles and spherical ZrO₂ particles may also be used for a sealing member 20 in a range in which spherical particles account for 30 vol % or less to 70 vol % or more of flaky talc particles.

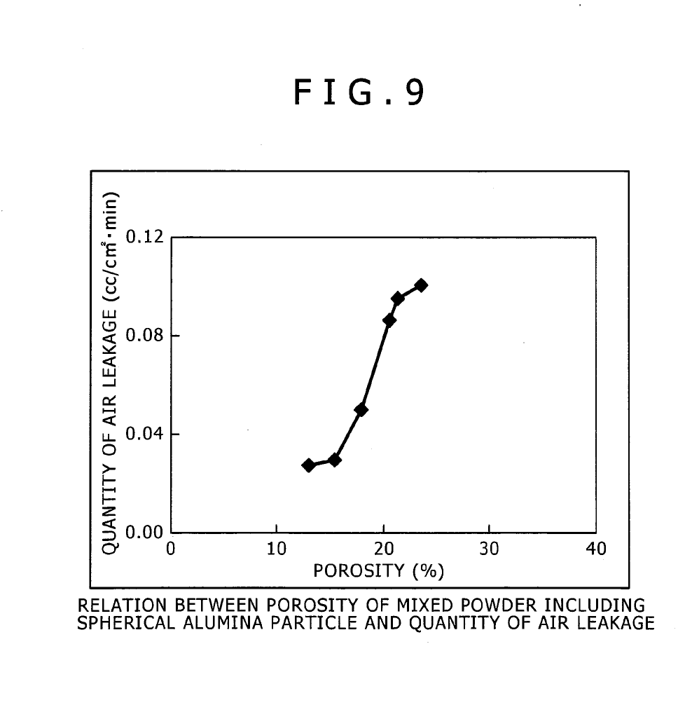

To verify the effect of sealing in this embodiment, an air leakage test is applied to the sealing material 11a made of mixed powder including flaky talc particles and spherical alumina particles. As for the sealing material used for the test, the weight of the powder is adjusted so as to make the thickness after compression molding fixed and the thickness is set to 3 mm. FIG. 9 is a graph showing the result of the test. As for the sealing material 11a in which spherical alumina particles are mixed, compared with the case that no spherical alumina particle is mixed, the porosity decreases and the quantity of air leakage also decreases significantly, and the improvement of the effect of sealing can be verified. To reduce the quantity of air leakage, it is an important element to reduce porosity and it can be verified that sealability is made satisfactory by reducing porosity to 20% or less.

As the oxygen sensor according to this embodiment is exposed to high temperature (approximately 600 degrees) environment, thermal expansion characteristics of the sealing material 11a are measured by laser beam thermal expansion measurement equipment. A thermal expansion coefficient of the detecting element is 7.4×10⁻⁶/° C., while that of the sealing material 11a to which no spherical alumina particle is added and which includes only flaky talc particles is 4.8×10⁻⁶/° C., however, when spherical alumina particles a thermal expansion coefficient of which is large are mixed with flaky talc particles by 45 vol % or less, the thermal expansion coefficient increases to 6.2×10⁻⁶/° C., and the effect of reducing difference in thermal expansion in high temperature environment and preventing the deterioration of the sealing material 11a is verified. In addition, a thermal expansion coefficient of a spherical SiO₂ particle is 0.5×10⁻⁶/° C., that of a spherical ZrO₂ particle is 7.8×10⁻⁶/° C., and on the same way to the case that spherical alumina particles are mixed, spherical alumina particles may also be mixed with flaky talc particles by 45 vol % or less. The sealing member 20 that can prevent the sealing material 11a from being peeled from the sensor body 3 in usage in high temperature environment can be produced by mixing spherical particles having the similar thermal expansion characteristics to the material of the sensor body 3 with talc.

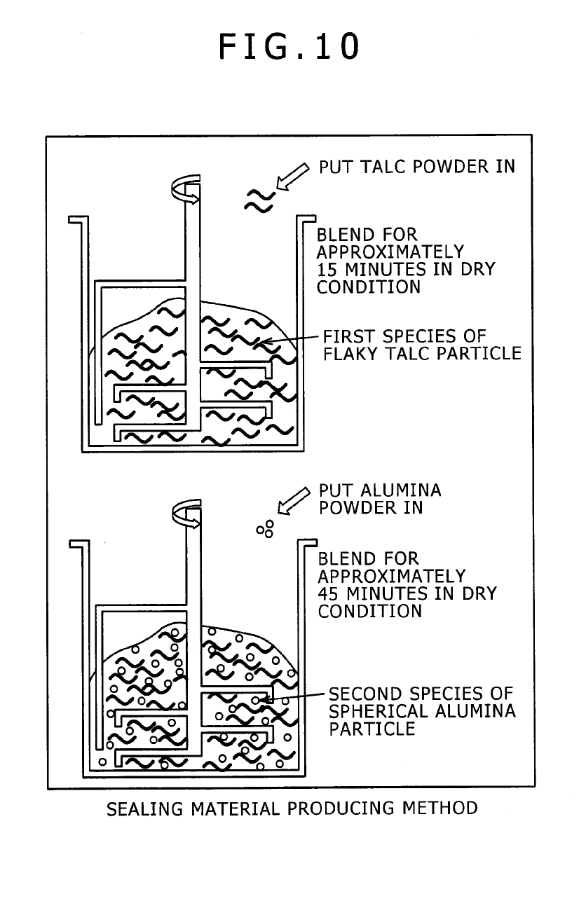

A method of producing the sealing material 11a used in the oxygen sensor 1 will be described below. Flaky talc particles are put in a mixing vessel as shown in FIG. 10 and are blended for approximately 15 minutes in a dry condition. Next, spherical alumina particles of provided quantity are mixed with the flaky talc particles and are blended for approximately 45 minutes in a dry condition to be mixed powder.

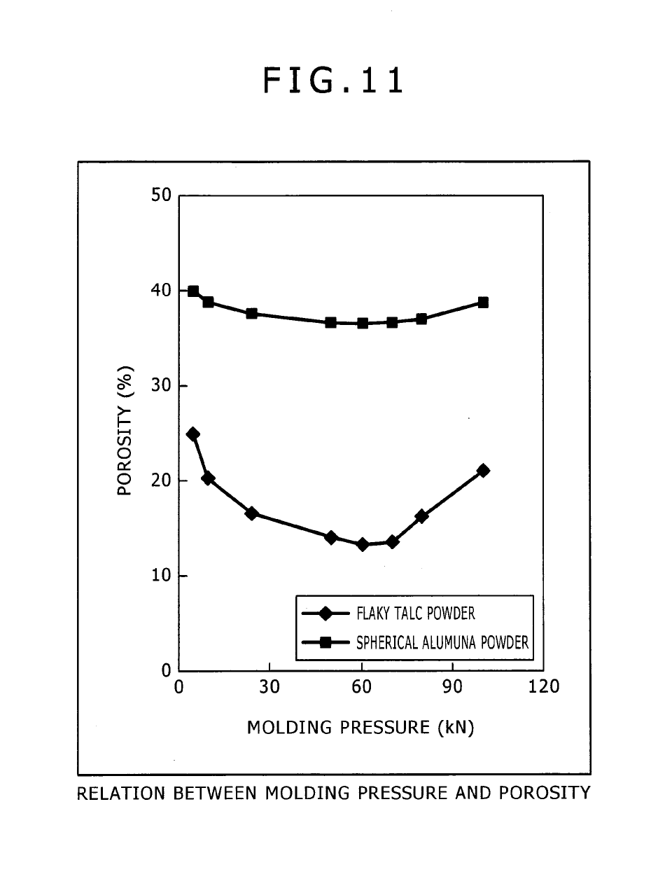

As for the used particles, a mean particle diameter of the flaky talc particle is 15 μm at D50% and that of the spherical alumina particle is 1.7 μm at D50% respectively in measurement by a laser diffraction type particle size meter. FIG. 11 shows the results of compression molding by a mechanical press for verifying the formability of the flaky talc particles and the spherical alumina particles. Powder used for molding is measured by an electronic force balance to be 0.5 g.

So-called dry blending has been described above. From a viewpoint of enhancing the dispersibility of particles in blending, wet blending (for example, after ethyl alcohol and others are added, dry powder is acquired by blending and drying) can also be applied.

As for the flaky talc particles, the porosity decreases on a pressurized condition on which molding pressure is 60 kN or less and the porosity increases when molding pressure is 70 kN or more. This reason is considered to be that since the talc particles in this embodiment are flaky, the particles repel each other under the molding pressure of 70 kN or more and are expanded at the same time as the release of compression pressure. As for spherical alumina particles, it is verified that the porosity decreases until molding pressure is 60 kN, but the variation is small. In a sealing material extraction process after compression molding, adhesion to a mold increases at 60 kN or more, chipped surface and side are verified, and the dimensional precision of the sealing member is deteriorated. Further, when the sealing material is 3 mm or less thick, multiple cracks are caused in an extraction process because the adhesion to the mold is very strong, when the sealing material is 15 mm or more thick, a crack and peeling respectively due to the repulsion of the particles are stratiformly caused, and the sealing material cannot be molded in dry blending. It is verified based upon the above-mentioned that the sealing material 12 having porosity of 13% can be molded by blending flaky talc particles under molding pressure in a range of 10 to 60 kN. However, large compressive force is required to acquire high density sealing material by only one species of flaky talc particles.

As described above, according to this embodiment, the high density sealing material is acquired with a small compressive load by using flaky particles and spherical particles for sealing material, and the detecting element and the holder can be firmly held without breaking a multilayer film formed on a surface of the detecting element.

Thermal characteristics of materials in using the oxygen sensor in high temperature environment can be coordinated by applying the effect of reducing an outflow of the sealing material 11a through predetermined clearance caused between the detecting element and the holder by the application of the spherical particles and the similar material to the detecting element, the deterioration of the sealing material 11a is prevented, and the high precision detection of an oxygen content is enabled.

Further, as the manageability is secured, no crank and peeling is caused in compression molding and dimensional precision is easily secured if only the thickness of the sealing material is between 3 mm and 15 mm, the miniaturization is possible without thickening the sealing material so much and the oxygen sensor having a high density and firm holding characteristic can be realized.

The oxygen content detecting element according to the invention has been described based upon the embodiment shown in the drawings. However, the invention is not limited to this, and the configuration of each part can be replaced with arbitrary configuration provided with the similar function.

In the above-mentioned embodiment, the sensor body 3 is cylindrically formed. However, the invention can be similarly applied to a sensor body in a shape except a cylindrical shape, for example, to a sensor body having a flat outside face.

In the embodiment, flaky talc particles a mean particle diameter of which is 5 to 25 μm and spherical alumina particles a mean particle diameter of which is 1 to 20 μm are used, however, the particle size may also be varied by in a range in which the effect of the invention is acquired.

In the embodiment, the example using flaky talc particles as the first species and spherical alumina particles as the second species has been mainly described. The first species is not limited to the flaky particle. When the length of a particle is L and a diameter of the second species of spherical particle is D, the first species of particle has only to be a flake particle the length L of which meets D/L≦0.7.

Further, in the embodiment, the flaky talc is used for the sealing material 11a. In the meantime, a substance except a flaky particle represented by talc, for example, mica that can be formed in layer structure in a compressive process may also be used.

In the embodiment, the example of the spherical particle as the second species has been described. However, the second species is not limited to the spherical particle.

For the first species, plural forms of flake particles that meet the above-mentioned conditions in addition to the flaky particle may also be included and for the second species, a spherical particle and an angular particle may also be included.

Finally, in the embodiment, the example of the oxygen sensor has been described. However, the invention can also be applied to a sensor that senses another gas.

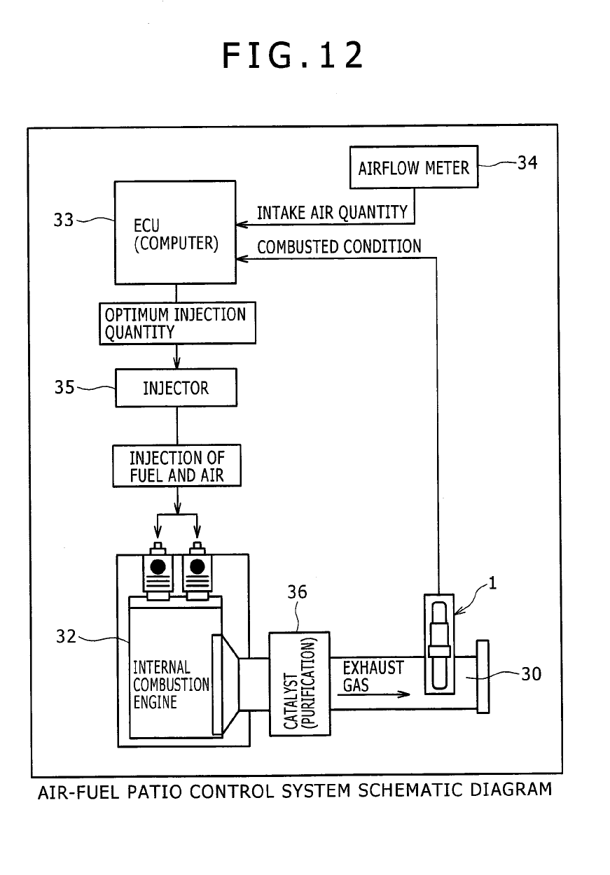

Next, referring to FIG. 12, an embodiment of an air-fuel ratio control system using the sealing material according to the invention will be described.

The air-fuel ratio control system 100 includes an internal combustion engine 32, an ECU 33 which is a computer that controls an injector 35 based upon the results of detection by an airflow meter 34 and the oxygen sensor 1 for detecting an oxygen content in the exhaust pipe 30 and that controls the injection quantity of fuel and air into the internal combustion engine 32 and a catalyst 36 for purifying exhaust gas from the internal combustion engine.

As the oxygen sensor 1 according to the above-mentioned embodiment can be used in high temperature environment of approximately 600 degrees, the sealing material reduces the quantity of air leakage by approximately 20%, compared with that in the related art and the effect of sealing can be greatly improved, high precision can be bestowed on air-fuel ratio control by the quantity.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

1. An oxygen sensor that includes an oxygen content detecting element and a holder holding the oxygen content detecting element and that seals the oxygen content detecting element in the holder by a sealing part in which sealing material is compressively filled,
wherein the sealing material is molded by mixed powder including a plurality of species of forms of particles.

2. The oxygen sensor according to claim 1,
wherein the mixed powder includes at least two species of forms of particles.

3. The oxygen sensor according to claim 2,
wherein a first species of the two species has a form of a flaky particle; and
a second species has a form of a spherical particle.

4. The oxygen sensor according to claim 3,
wherein a content of the spherical particles to the flaky particles is set to 45 vol % or less.

5. The oxygen sensor according to claim 3,
wherein when a length of the flaky particle is L and a diameter of the spherical particle is D, D/L≦0.7.

6. The oxygen sensor according to claim 3,
wherein the flaky particle which is the first species is talc; and
the spherical particle which is the second species includes at least one of alumina (Al₂O₃), SiO₂ and ZrO₂.

7. The oxygen sensor according to claim 6,
wherein a mean particle diameter of the flaky talc particle is set to 5 to 25 μm; and
a mean particle diameter of the spherical alumina particle is set to 0.5 to 10 μm.

8. The oxygen sensor according to claim 2,
wherein the second species of the two species has a form of a spherical particle; and
the first species has a form of a flake particle a content to the spherical particle of which is 55 vol % or more.

9. A gas sensor which is a gas content detecting sensor that includes a gas content detecting element and a holder holding the gas content detecting element and that seals a measuring part of the gas content detecting element in the holder by a sealing part in which sealing material is compressively filled,
wherein the sealing material is molded by mixed powder including a plurality of species of forms of particles.

10. An air-fuel ratio control system comprising:
an internal combustion engine;
an oxygen sensor that detects an oxygen content included in exhaust gas from the internal combustion engine; and
a computer that controls an air-fuel ratio based upon output from the oxygen sensor,
wherein the oxygen sensor is provided with a sealing part in which sealing material is compressively filled and which seals a measuring part of the oxygen sensor; and
the sealing material is molded by mixed powder including a plurality of species of forms of particles.

11. The air-fuel ratio control system according to claim 10,
wherein a first species of the plurality of species of forms of particles has a form of a flaky particle; and
a second species has a form of a spherical particle.
